(19) United States
(12) Patent Application Publication
(10) Pub. No.: US 2009/0242529 A1
(43) Pub. Date: Oct. 1, 2009

(54) Method to cut apertures in a material

(76) Inventors: David G. Groll, Murrysville, PA (US); William A. Groll, McMurray, PA (US); John Milnthorp, McMurray, PA (US)

Correspondence Address: The Law Firm of Carl A. Ronald, 20120 Route 19, Suite 105, #146, Cranberry Township, PA, 16066, US

(21) Appl. No.: 12/079,962

(22) Filed: Mar. 31, 2008

(51) Int. Cl. B23K 26/38

(52) U.S. Cl. 219/121.71

(57) ABSTRACT

A method is described for the cutting of apertures in a material using a computer, laser control software, input device, laser and an x-y plotting bed. The method is to preferably form apertures in fluid impermeable material including composite materials. The apertures are used as exhaust valves in positive pressure masks to deliver breathable gas to patients and in garments.

### FIELD OF THE INVENTION

The present invention relates, in general, to a method of forming precise apertures in material and, more particularly, this invention relates to a method of forming apertures in material to control air flow in positive pressure masks.

### BACKGROUND OF THE INVENTION

Prior to the conception and development of the present invention, as is generally well known in the prior art, to use a laser to cut fabric and film. The use of a bed to hold the work piece is well known. Pulse lasers to cause ablation to materials and to prepare cells in nonwoven fabric are known. However, the use a laser to form precise apertures in material to for use as exhaust valves in positive pressure masks and other uses as vents is not described in the prior art.

In the U.S. non provisional application No. ______ filed Feb. 28, 2008, a face mask is described that is used to treat persons with Obstructive Sleep Apnea. Treatment involves applying a positive pressure to the person's upper airway by means of a mask worn while sleeping. Air is supplied to the mask by means of a pumping device that provides positive pressure such as the machines such as those marketed as Respironics™ and Resmed®. The pump supplies air to the mask which is worn on the face of the user. The functionality and comfort of the mask are largely dependent on the compliance of the mask to the user's face and the maintenance of a good seal between the mask and the user's face. There are numerous designs of masks which have been made of a wide range of materials. Attempts have been made to mold masks from soft plastic materials and to fit these constructions with various devices to control the flow of exhaled air. This has lead to a generation of masks which are cumbersome and uncomfortable for the user. Despite the many advances made in the science of the treatment of Obstructive Sleep Apnea, mask comfort remains a difficult aspect of the treatment of this condition.

### SUMMARY OF THE INVENTION

The present invention provides method to use a computer driven material cutting apparatus having a laser to produce apertures in materials particularly fluid impermeable materials. Such apertures are useful as exhaust valves in positive pressure masks to deliver breathable gas to patients by exhausting and other uses to exhaust excess and breathed gas that has a higher than ambient concentration of CO₂ and higher than ambient humidity. Apertures are also useful in garments as vents.

The present invention uses a computer driven laser cutter and an x-y bed. Information concerning the position, shape and size of an aperture are entered into the computer with an input device. The in the preferred embodiment, the preferred shape is generally circular and a size of about 0.005 inches. In the preferred embodiment, a plurality of apertures and a pattern are also entered using an input device. The laser power is set and the work piece is positioned on the x-y plotter bed. The user enters a command to run the software and the software processes the information and directs the laser cutter.

The material is preferably a fluid impermeable material and in the presently preferred embodiment, a composite material with a fabric cloth layer and a generally soft plastic layer. Previous methods were unable to produce apertures with dimensions on this scale and patterns of apertures. The method is provided for cutting the material using laser technology. The method provides for a means to precisely control the size, number, shape and array pattern of the apertures. This method also provides for economical means of construction.

The relationship between the number, shape and size of apertures is important to determine the performance of the mask. This relationship is demonstrated in FIG. 1, which shows the airflow through a number exhalation valves made with different configurations of apertures. In this example, all apertures are circular.

The resistance to airflow is greater through many small apertures than through one large aperture with the same geometric area. For example, 500 apertures of diameter 0.005 inch have a total geometric area of 0.0098 square inch. This aperture 500 aperture arrangement will offer more resistance to air flow than a single aperture of diameter 0.112 inch which has the same geometric area of 0.0098 square inch. This is due to turbulence, friction and air viscosity. It should be noted that the gas flow of the mask can be finely adjusted by the addition or subtraction of the number of apertures or alteration of shape and diameter. This fine control of air flow is attainable by virtue of the highly precise control attainable with the laser technique.

The dispersion of small apertures also buffers the air flow exiting the mask thus avoiding a bothersome air stream that may blow against the skin of the mask user or the bed partner and disturb sleep. The perforated array technique also allows for quieter operation of the mask. The quiet operation is especially important because such masks are most often used at night.

It should also be noted that the array of apertures can be arranged in a “dot matrix” manner to graphically create an image. This technique is useful in product branding, identification or production run identification. The application of laser technique allows for an apparatus which is very lightweight, flexible and compliant to the face of the user. The application of the laser technique allows for the economical production of the mask and provides for very repeatable production output.

The highly accurate nature of laser cutting allows for the creation of an array of apertures that serve as an exhaust valves for air flow without adding undue cost, complexity or weight to the product.

Laminated fabric cloth layer and a plastic layer is used to create a material which is soft and non-abrasive to human skin, but which is impermeable to air flow. Rectangular pieces of material are placed onto the cutting bed of a 30 watt CO₂ laser. A program to optimize material consumption and minimize folds and seams is loaded into the computer which controls the actions of the laser. All cutting and marking is done in the X-Y plane. The Z position is carefully set to the prescribed focal length for this particular laser. The profile cutting of the silhouette is done in vector cutting mode, but the laser also executes in raster mode at varying power settings to mark the material with critical information such as production lot and to execute the raster pattern that becomes the exhalation apertures. The cut pattern is sewn into a final product as described in patent application filed Feb. 28, 2008 entitled “Apparatus To Provide Continuous Positive Airway Pressure”, no serial number has been assigned. The resulting product exhibits ease of use, comfort and reliable performance.

Additionally, this method can be applied to the manufacture of garments where the piece requires apertures as a vent or for ornamental purposes.

### OBJECTS OF THE INVENTION

It is, therefore, one of the primary objects of the present invention to provide a method to form precise apertures in materials.

Another object of the present invention is to provide a method to form apertures in fluid impermeable materials

Still another object of the present invention is to provide a method of forming apertures in composite materials.

Yet another object of the present invention is to provide a method of forming a pattern of a plurality of apertures.

An additional object of the present invention is to provide a method of forming apertures of a predetermined shape.

A further object of the present invention is to provide a method of forming circular, quadrilateral, polygonal, and irregular shapes.

A further purpose of the present invention is provide a method for the manufacture of precisely controlled exhaust valves in positive pressure air masks for patients

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a diagram of flow through the exhalation valve vs. the applied pressure.

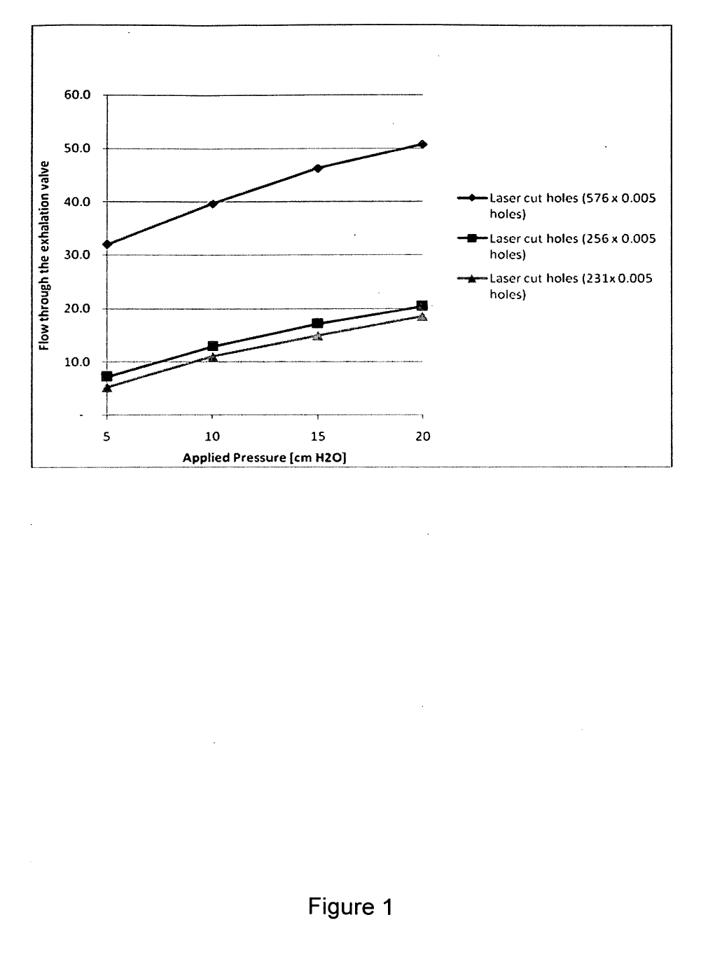

FIG. 2 is a flow chart of the presently preferred embodiment of the method.

FIG. 2A is a flow chart that is a continuation of FIG. 2.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

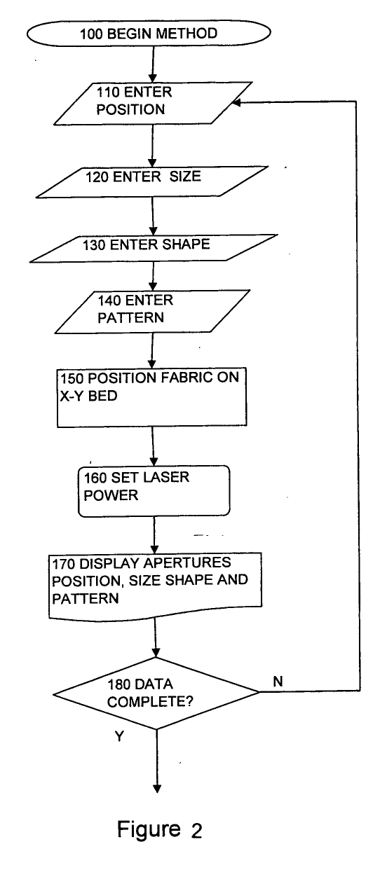

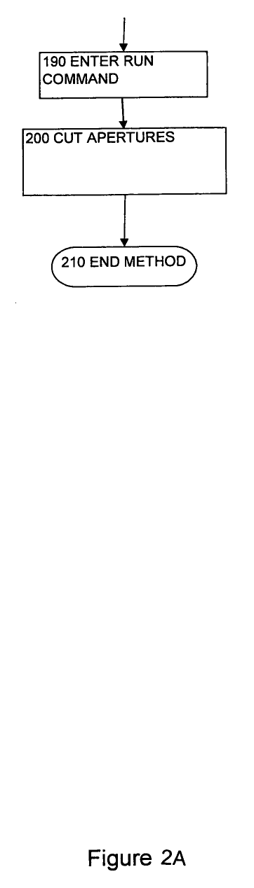

Reference is now made, more particularly, to FIG. 2. Using a computer with cutting control software, a laser and x-y bed, the user enters aperture.

The user enters position information 110 for the at least one aperture by an input device into a computer with laser cutting control software. In the preferred embodiment, the user enters aperture predetermined size 120, predetermined shape 130 and predetermined pattern 140 including the spacing. The material is positioned on the x-y bed 150. The power of the laser is set 160. In the preferred embodiment, the aperture shape, size, and pattern of apertures, including aperture number is displayed 170 on an output device. The output device includes computer monitor, plotter, and printer. When all data has been entered 180, the user enters a run command 190 to initiate cutting. The apertures are then cut 200.

The predetermined material includes woven and non-woven fabric, fluid impermeable material and composite material. The composite material includes a composite fluid impermeable layer such as a generally soft plastic and cloth.

The input device can be a keyboard, storage media with a predetermined file format or scanner. The x-y bed refers to bed to hold the work piece in fixed position for cutting in the x-y plane. The laser, the x-y bed, or both may move along the longitudinal and transverse axis of the x-y bed and may rotate into a plurality of cutting position.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

We claim:

1. A method of manufacture for apertures in material comprising:
entering position information into a computer driven laser cutter control software with an input device,
entering aperture size information into said software with said input device;
entering said aperture predetermined shape and size of aperture to be cut,
setting the power of laser emission;
positioning a predetermined material on an x-y bed;
entering a command to run said software to process said position information, said size and said shape of said at least one aperture, energizing said laser; and
cutting at least one aperture in said predetermined material by laser.

2. A method of claim 1 further including the step of entering a predetermined pattern of apertures and spacing of said aperture into said software with said input device before issuing said command to run said and then cutting a plurality of apertures.

3. A method according to claim 1 wherein said predetermined material is a fluid impermeable material.

4. A method according to claim 3 wherein said fluid impermeable material is a composite material with a cloth layer and a generally soft plastic layer.

5. A method according to claim 2 wherein said material and said x-y plotting bed remains in position and said laser moves along longitudinal and transverse axes of said bed and rotates to a plurality of cutting positions.

6. A method according to claim 2 wherein said laser remains in a generally fixed position and said x-y plotting bed with said material positioned on said bed moves along said bed's longitudinal and transverse axes and rotates to a plurality of cutting positions.

7. A method according to claim 2 wherein said computer program further step of displaying said pattern, said size and said shape of said apertures to an output device prior to entering said command to run said software.

8. A method according to claim 7 wherein said output device is one of a printer, plotter and monitor.

9. A method according to claim 2 wherein said predetermined shape of said apertures is one of circular, quadrilateral, polygonal or irregular;

10. A method according to claim 2 wherein said predetermined size of said apertures is approximately 0.001″ to 0.020″ inches.

11. A method according to claim 2 where in said aperture spacing is approximately equal to or greater than 0.005 inches.

12. A method according to claim 2 wherein said input device is an optical scanner.

13. A method according to claim 2 wherein an additional step of displaying said aperture pattern, size and shape on a monitor prior to entering said command to run said software.

14. A method according to claim 2 wherein the predetermined pattern of apertures are arranged to create a graphic image.

15. A method of manufacture for exhaust valves for a positive pressure mask for with precise and accurate control of air flow comprising:
entering position information into a computer driven laser cutter control software with an input device,
entering aperture size information into said software with said input device;
entering said aperture predetermined shape and size of aperture to be cut with said input device,
entering a predetermined pattern of apertures and spacing of said aperture with said input device;
setting the power of laser emission;
positioning a predetermined material on an x-y plotter bed;
entering a command to run said software to process said position information, said size and said shape, pattern of said apertures, energizing said laser; and
cutting said plurality of apertures in said predetermined material said plurality of apertures for precise and accurate air flow in a positive pressure mask exhausted through said apertures.

16. A method according to claim 15 wherein said predetermined pattern of apertures has approximately 231 apertures.
